(19) United States
(12) Patent Application Publication
(10) Pub. No.: US 2015/0009197 A1
(43) Pub. Date: Jan. 8, 2015

(54) VIDEO OUTPUT SYSTEM AND LOAD DETECTING METHOD THEREFOR

(71) Applicant: FARADAY TECHNOLOGY CORPORATION, Hsinchu (TW)

(72) Inventors: Feng Xu, Suzhou (CN); Min-Yuan Wu, Hsinchu City (TW); Chia-Ta Lai, Taipei City (TW); Xing-Bo Ding, Suzhou (CN)

(73) Assignee: FARADAY TECHNOLOGY CORPORATION, Hsinchu (TW)

(21) Appl. No.: 14/150,214

(22) Filed: Jan. 8, 2014

(30) Foreign Application Priority Data
Jul. 5, 2013 (CN) 201310282305.1

(51) Int. Cl. G09G 5/00

(52) U.S. Cl. CPC G09G 5/00
USPC 345/212

(57) ABSTRACT

A video output system at least includes a first video output terminal, a control circuit, a first digital-to-analog converter, and a first bias voltage generator. The first video output terminal is selectively connected with a first video input terminal of a display device through a signal cable. According to a constant detecting current generated by the first digital-to-analog converter, or the first bias voltage generator, the first video output terminal has a detecting voltage for indicating whether the video output system is connected with the display device. When the video output system is connected with the display device, the control circuit enables the first digital-to-analog converter but disables the first bias voltage generator. When the video output system is not connected with the display device, the control circuit disables the first digital-to-analog converter but enables the first bias voltage generator.

This application claims the benefit of People's Republic of China Patent Application No. 201310282305.1, filed Jul. 5, 2013, the subject matter of which is incorporated herein by reference.

### FIELD OF THE INVENTION

The present invention relates to a video output system, and more particularly to a video output system with a load detecting device and a load detecting method for the video output system.

### BACKGROUND OF THE INVENTION

A video output system of a multimedia apparatus is usually equipped with plural signal output interfaces for transmitting video signals in different formats. According to a signal input interface of a television or a monitor, a matching signal output interface of the video output system is in communication with the signal input interface through a corresponding cable. The standard formats of video signals provided by the video output system include for example composite video broadcast signals (CVBS signals), separate video signals (S-Video signals), YUV signals, RGB signals, and the like.

Generally, the signals processed by the video output system are in a digital form. However, most of the current televisions or monitors are designed to receive and display analog signals. Consequently, the signals in the video output system should be converted into analog signals. Conventionally, a digital-to-analog converter (DAC) is used to convert digital video signals into analog signals.

Since the video output system can support various signal output interfaces complying with different specifications, during signal conversion, the digital video signals are converted into various analog signals according to these specifications. As known, the television or the monitor in communication with the video output system only has to receive and display analog signals in a specified format. However, the digital-to-analog converter of the video output system is continuously enabled to convert digital video signals into analog signals corresponding to the unavailable input interfaces. In other words, the way of outputting various analog signals increases the burden of the digital-to-analog converter, and causes unnecessary power consumption. Consequently, it is an important issue to research how to solve the above drawbacks.

For solving the above problems, an adjustable digital-to-analog converter is disclosed in for example U.S. Pat. No. 7,583,216, which is entitled “Adjustable DAC and applications thereof”. By detecting whether a specified signal cable is coupled, a corresponding digital-to-analog converter is controlled to be enabled or disabled. Consequently, a power-saving purpose is achieved. In particular, the output terminal of the corresponding digital-to-analog converter has a jack sensing element, and a pull-up resistor is disposed within the jack sensing element. By detecting whether the corresponding signal cable is connected with and plugged into the jack sensing element, the connection status of the digital-to-analog converter relative to the output load can be judged. According to the connection status of the digital-to-analog converter, the digital-to-analog converter is controlled to be enabled or disabled.

For example, if the output terminal of the digital-to-analog converter is not connected to the signal cable load, the voltage of the output terminal is influenced by the pull-up resistor. Under this circumstance, the voltage of the output terminal is in a first state. Whereas, if the output terminal of the digital-to-analog converter is connected to the signal cable load, a closed circuit between the jack sensing element and the signal cable load is established. Under this circumstance, the voltage of the output terminal is in a second state. In other words, the voltage of the output terminal may be used to judge whether the output terminal of the digital-to-analog converter is connected to the signal cable load. Moreover, if the output terminal of the digital-to-analog converter is not connected to the signal cable load, the digital-to-analog converter is controlled to be disabled. Consequently, the power-saving purpose is achieved.

The method of the above literature is effective to achieve the power-saving purpose by a simply judgment method. However, the special circuitry configuration increases the fabricating cost and the design complexity. In addition, the applications of this method are restricted. For example, the judgment about whether the jack sensing element and corresponding signal cable is performed only when the digital-to-analog converter is disabled (e.g. during the start-up procedure). That is, if the digital-to-analog converter is enabled to output signals, it is unable to judge whether the jack sensing element and corresponding signal cable are connected with each other. Consequently, the conventional technology is not user-friendly. Moreover, since a switch is added to the resistor of the output terminal, the output performance of the digital-to-analog converter is deteriorated.

Therefore, there is a need of providing improved method and device in order to eliminate the above drawbacks.

### SUMMARY OF THE INVENTION

The present invention provides a video output system and a load detecting method for the video output system. The video output system may transmit video signals in various formats to a display device. By determining whether the video output system is connected with the load, the digital-to-analog converter of the video output system is selectively enabled or disabled. Consequently, the power-saving efficacy is enhanced.

An embodiment of the present invention provides a video output system having a function of detecting whether the video output system is connected with a display device during a load detecting time interval. The video output system at least includes a first video output terminal, a control circuit, a first digital-to-analog converter, and a first bias voltage generator. The first video output terminal is selectively connected with a first video input terminal of the display device through a signal cable. The control circuit is used for generating a first digital video signal, a first control signal and a second control signal. When the first digital-to-analog converter is enabled according to the first control signal, a detecting value of the first digital video signal is converted into a constant detecting current to the first video output terminal by the first digital-to-analog converter. When the first digital-to-analog converter is disabled according to the first control signal, the first bias voltage generator is enabled according to the second control signal, so that the first bias voltage generator generates the constant detecting current to the first video output terminal. According to the constant detecting current, the first video output terminal has a detecting voltage for indicating whether the video output system is connected with the display device. When the video output system is connected with the display device, the control circuit enables the first digital-to-analog converter but disables the first bias voltage generator. When the video output system is not connected with the display device, the control circuit disables the first digital-to-analog converter but enables the first bias voltage generator.

Another embodiment of the present invention provides a load detecting method for detecting whether a video output system is connected with a display device during a load detecting time interval. The video output system includes a video output terminal, a digital-to-analog converter and a bias voltage generator. The video output terminal is selectively connected with the display device. The load detecting method includes steps: (a1) enabling the digital-to-analog converter but disabling the bias voltage generator, (a2) allowing the digital-to-analog converter to generate a detecting current to the video output terminal, (a3) judging whether the video output system is connected with the display device according to a detecting voltage at the video output terminal, (a4) if the video output system is connected with the display device, repeatedly performing the step (a1), or if the video output system is not connected with the display device, performing a step (b1), (b1) disabling the digital-to-analog converter but enabling the bias voltage generator, (b2) allowing the bias voltage generator to generate the detecting current to the video output terminal, (b3) judging whether the video output system is connected with the display device according to the detecting voltage at the video output terminal, and (b4) if the video output system is connected with the display device, repeatedly performing the step (a1), or if the video output system is not connected with the display device, performing the step (b1).

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic functional block diagram illustrating the architecture of a video output system with a load detecting device according to a first embodiment of the present invention;

FIG. 2 is a schematic functional block diagram illustrating the architecture of a video output system with a load detecting device according to a second embodiment of the present invention;

FIG. 3 is a schematic functional block diagram illustrating the architecture of a video output system with a load detecting device according to a third embodiment of the present invention; and

FIG. 4 is a flowchart illustrating a load detecting method for a video output system according to an embodiment of the present invention.

### DETAILED DESCRIPTION OF PREFERRED EMBODIMENTS

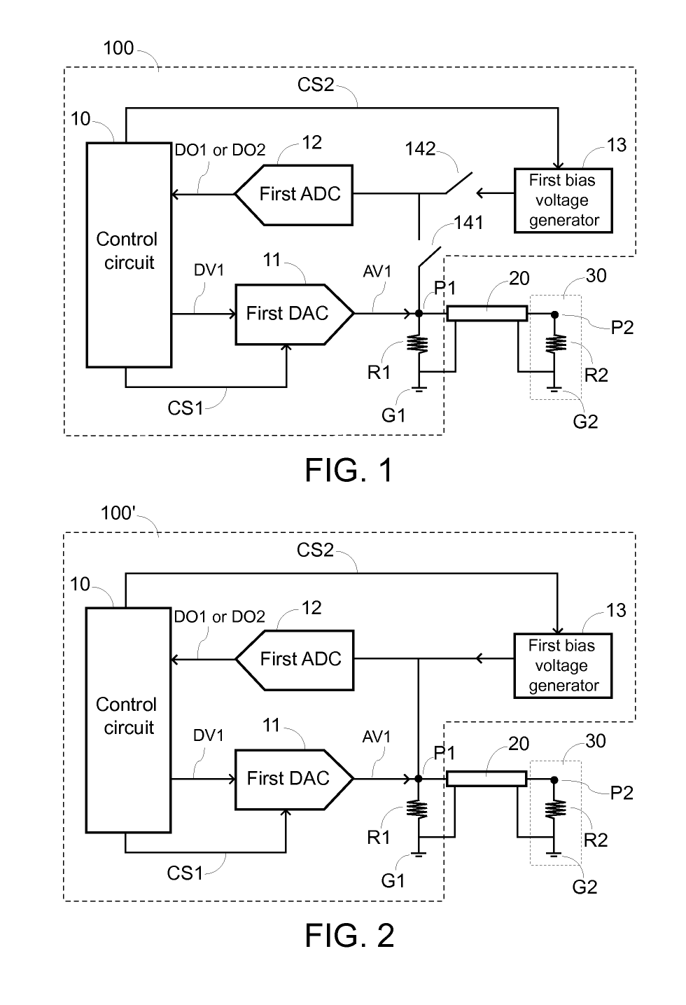

Hereinafter, a video output system with a load detecting device according to a first embodiment of the present invention will be illustrated with reference to FIG. 1. FIG. 1 is a schematic functional block diagram illustrating the architecture of a video output system with a load detecting device according to a first embodiment of the present invention. As shown in FIG. 1, the video output system 100 comprises a first resistor R1, a first switch 141, a second switch 142, a control circuit 10, a first digital-to-analog converter (DAC) 11, a first bias voltage generator 13, a first analog-to-digital converter (ADC) 12, and a first video output terminal P1. The video output system 100 may be connected with a display device 30. An example of the display device 30 includes but is not limited to a television or a monitor. Moreover, the video output system 100 is a TV box, a video player, a surveillance system or a TV game console. Basically, the control circuit 10 cooperates with the first switch 141, the second switch 142, the first bias voltage generator 13 and/or the first analog-to-digital converter 12 to perform a load detecting operation.

Please refer to FIG. 1 again. The first video output terminal P1 is connected with the display device 30 through a signal cable 20. The control circuit 10 may issue a first digital video signal DV1 to the first digital-to-analog converter 11. Moreover, the control circuit 10 may issue a first control signal CS1 to the first digital-to-analog converter 11 in order to control the enabling or disabling state of the first digital-to-analog converter 11. Moreover, the control circuit 10 may issue a second control signal CS2 to the first bias voltage generator 13 in order to control the enabling or disabling state of the first bias voltage generator 13.

In case that the first digital-to-analog converter 11 is enabled, the first digital video signal DV1 is converted into a first analog video signal AV1 by the first digital-to-analog converter 11, and the first analog video signal AV1 is outputted from the first video output terminal P1. Whereas, in case that the first digital-to-analog converter 11 is disabled, the first digital-to-analog converter 11 does not convert the first digital video signal DV1 and output the first analog video signal AV1. Moreover, the first resistor R1 of the video output system 100 is connected between the first video output terminal P1 and a first ground terminal G1. Moreover, the display device 30 comprises a first video input terminal P2 and a second resistor R2. The second resistor R2 is connected between the first video input terminal P2 and a second ground terminal G2.

In this embodiment, only one digital-to-analog converter for converting one digital video signal into a corresponding analog video signal is shown in FIG. 1 for illustration. In some other embodiments, various digital video signals from the control circuit 10 may be converted into analog video signals in various formats, and the analog video signals are outputted from the video output terminals that comply with the corresponding formats.

The first analog video signal AV1 is a composite video broadcast signal (a CVBS signal), a separate video signal (an S-Video signal), a YUV signal, a RGB signal or the like. The video output system 100 is capable of converting and outputting video signals in various formats. The first analog video signal AV1 shown in FIG. 1 is in one of these formats. On the other hand, the video signals in other formats are converted and outputted by other digital-to-analog converters.

In accordance with a feature of the present invention, the first switch 141 and the second switch 142 are selectively turned on or turned off according to the enabling or disabling state of the first digital-to-analog converter 11 or the first bias voltage generator 13. Consequently, the subsequent detecting procedure may be performed to realize whether the first video output terminal P1 is connected with any display device (also referred as a load).

Please refer to FIG. 1 again. The input terminal of the first digital-to-analog converter 11 is connected with the control circuit 10 for receiving the first digital video signal DV1. The output terminal of the first digital-to-analog converter 11 is connected with the first video output terminal P1 for outputting the first analog video signal AV1. The first switch 141 is connected with the first video output terminal P1 and the input terminal of the first analog-to-digital converter 12. The second switch 142 is connected between the output terminal of the first bias voltage generator 13 and the input terminal of the first analog-to-digital converter 12. Moreover, the output terminal of the first analog-to-digital converter 12 is connected with the control circuit 10.

When the first digital-to-analog converter 11 is enabled or when the first digital-to-analog converter 11 is disabled but the first bias voltage generator 13 is enabled, the first switch 141 is turned on. On the other hand, when the first digital-to-analog converter 11 is enabled, the second switch 142 is turned off. When the first digital-to-analog converter 11 is disabled but the first bias voltage generator 13 is enabled, the second switch 142 is turned on.

Moreover, when no effective video signal can be transmitted between the display device 30 and the video output system 100, the load detecting method of the present invention is performed. For example, the load detecting method of the present invention can be performed during a load detecting time interval. The load detecting time interval is a time interval while the first analog video signal AV1 is not outputted from the first video output terminal P1 to the display device 30, or the load detecting time interval indicates a vertical blank interval (VBI) of the first analog video signal AV1.

When the first digital-to-analog converter 11 is enabled and the load detecting method is performed, the first digital video signal DV1 with a detecting value is generated by the control circuit 10. Consequently, the first analog video signal AV1 outputted from the first digital-to-analog converter 11 is a constant detecting current. According to the specifications, the first resistor R1 of the video output system 100 and the second resistor R2 of the display device 30 are both 75 ohms.

Please refer to FIG. 1 again. When the first video output terminal P1 is connected with the display device 30 (i.e. the load) through the signal cable 20, if the constant detecting current is outputted from the first digital-to-analog converter 11, the first video output terminal P1 generates a first detecting voltage. In this situation, the first detecting voltage is equal to the product of the detecting current and 37.5 ohms. The first detecting voltage is transmitted through the first switch 141 and inputted into the input terminal of the first analog-to-digital converter 12. In response to the first detecting voltage, the first analog-to-digital converter 12 generates a first result value DO1 to the control circuit 10.

On the other hand, when the first video output terminal P1 is disconnected from the display device 30 (not shown) through the signal cable 20, if the constant detecting current is outputted from the first digital-to-analog converter 11, the first video output terminal P1 generates a second detecting voltage. In this situation, the second detecting voltage is equal to the product of the detecting current and 75 ohms. The second detecting voltage is transmitted through the first switch 141 and inputted into the input terminal of the first analog-to-digital converter 12. In response to the second detecting voltage, the first analog-to-digital converter 12 generates a second result value DO2 to the control circuit 10. Obviously, the second result value DO2 is larger than the first result value DO1.

Consequently, a threshold value between the first result value DO1 and the second result value DO2 may be set in the control circuit 10. The threshold value may be used to judge whether the video output system 100 is connected with the display device 30 through the signal cable 20. If the first result value DO1 is received by the control circuit 10, the control circuit 10 can judge that the video output system 100 is connected with the display device 30 because the first result value DO1 is smaller than the threshold value. Whereas, if the second result value DO2 is received by the control circuit 10, the control circuit 10 can judge that the video output system 100 is disconnected from the display device 30 because the second result value DO2 is larger than the threshold value. Consequently, after the control circuit 10 judges that the video output system 100 is disconnected from the display device 30, the first digital-to-analog converter 11 is disabled according to the first control signal CS1. Under this circumstance, the power consumption of the first digital-to-analog converter 11 is reduced.

Moreover, since the first digital-to-analog converter 11 is disabled according to the first control signal CS1, the detecting current is no longer outputted from the first digital-to-analog converter 11. Meanwhile, the first bias voltage generator 13 is enabled by the control circuit 10 according to the second control signal CS2. Consequently, the first bias voltage generator 13 generates a constant detecting current, and the detecting current is transmitted to the first video output terminal P1 through the second switch 142 and the first switch 141.

Next, when the first video output terminal P1 is connected with the display device 30 (i.e. the load) through the signal cable 20, the first video output terminal P1 generates the first detecting voltage. In this situation, the first detecting voltage is equal to the product of the detecting current and 37.5 ohms. The first detecting voltage is transmitted through the first switch 141 and inputted into the input terminal of the first analog-to-digital converter 12. In response to the first detecting voltage, the first analog-to-digital converter 12 generates the first result value DO1 to the control circuit 10.

On the other hand, when the first video output terminal P1 is disconnected from the display device 30 (not shown) through the signal cable 20, the first video output terminal P1 generates the second detecting voltage. In this situation, the second detecting voltage is equal to the product of the detecting current and 75 ohms. The second detecting voltage is transmitted through the first switch 141 and inputted into the input terminal of the first analog-to-digital converter 12. In response to the second detecting voltage, the first analog-to-digital converter 12 generates the second result value DO2 to the control circuit 10.

Consequently, the threshold value set in the control circuit 10 may be used to judge whether the video output system 100 is connected with the display device 30 through the signal cable 20. After the control circuit 10 judges that the video output system 100 is connected with the display device 30, the first digital-to-analog converter 11 is enabled according to the first control signal CS1 and the first bias voltage generator 13 is disabled according to the second control signal CS2. Meanwhile, the first digital-to-analog converter 11 is normally operated to output the first analog video signal AV1 to the display device 30.

For example, in an embodiment, the constant detecting current is 8 mA, the first detecting voltage is 300 mV, and the second detecting voltage is 600 mV. Since the detecting current is constant, the detecting voltage is in direct proportion to the magnitude of the resistor. According to the detecting voltage, the control circuit 10 can judge whether the first video output terminal P1 is in communication with the display device 30 or not, thereby correspondingly enabling or disabling the first digital-to-analog converter 11 and the first bias voltage generator 13.

From the above discussions, the present invention provides a video output system with a load detecting device. In case that the first digital-to-analog converter 11 is disabled, the first bias voltage generator 13 is responsible for providing the detecting current to detect the detecting voltage of the first video output terminal P1. Consequently, even if the first digital-to-analog converter 11 is disabled, the control circuit 10 is still able to effectively judge whether the first video output terminal P1 is connected with the display device 30. In case that the first video output terminal P1 is not in communication with the display device 30, the first digital-to-analog converter 11 is disabled and thus the power-saving efficacy is enhanced.

Moreover, even if the first switch 141 and the second switch 142 are omitted, the functions of the above load detecting device can be achieved. FIG. 2 is a schematic functional block diagram illustrating the architecture of a video output system with a load detecting device according to a second embodiment of the present invention. In comparison with the first embodiment, the first switch and the second switch are not included in the video output system 100′ of the second embodiment. The other components and the connecting relationships between these components are similar to those of the first embodiment, and are not redundantly described herein.

When the first digital-to-analog converter 11 is enabled, the first digital video signal DV1 with the detecting value is generated by the control circuit 10. Consequently, the first analog video signal AV1 outputted from the first digital-to-analog converter 11 is a constant detecting current. If the first video output terminal P1 generates the first detecting voltage, the first analog-to-digital converter 12 generates the first result value DO1 to the control circuit 10. According to the first result value DO1, the control circuit 10 judges that the video output system 100 is connected with the display device 30. On the other hand, if the first video output terminal P1 generates the second detecting voltage, the first analog-to-digital converter 12 generates the second result value DO2 to the control circuit 10. According to the second result value DO2, the control circuit 10 judges that the video output system 100 is not connected with the display device 30.

When the first digital-to-analog converter 11 is disabled, the first bias voltage generator 13 is enabled by the control circuit 10. Consequently, the first bias voltage generator 13 generates the constant detecting current. If the first video output terminal P1 generates the first detecting voltage, the first analog-to-digital converter 12 generates the first result value DO1 to the control circuit 10. According to the first result value DO1, the control circuit 10 judges that the video output system 100 is connected with the display device 30. On the other hand, if the first video output terminal P1 generates the second detecting voltage, the first analog-to-digital converter 12 generates the second result value DO2 to the control circuit 10. According to the second result value DO2, the control circuit 10 judges that the video output system 100 is not connected with the display device 30.

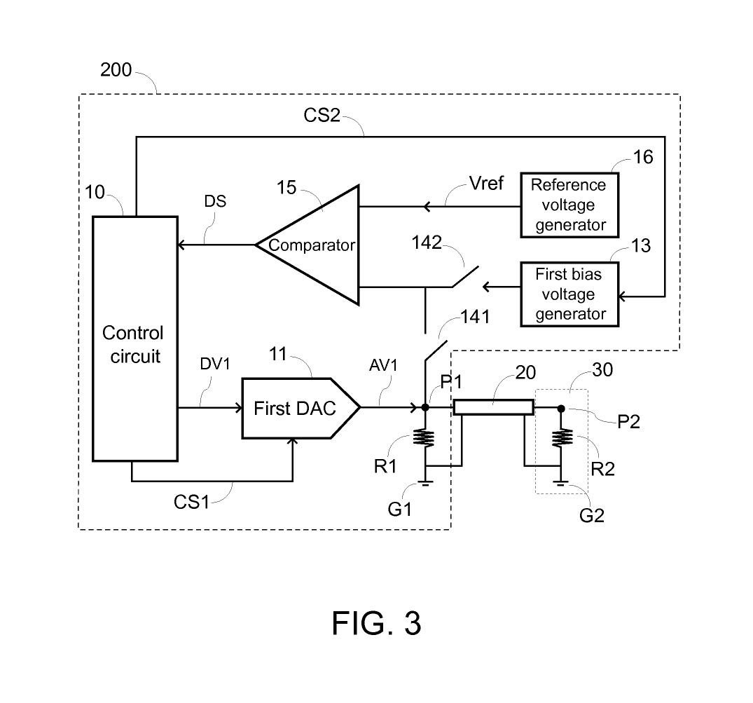

It is noted that numerous modifications and alterations may be made while retaining the teachings of the invention. FIG. 3 is a schematic functional block diagram illustrating the architecture of a video output system with a load detecting device according to a third embodiment of the present invention. In comparison with the first embodiment, the video output system 200 of the third embodiment as shown in FIG. 3 further comprises a reference voltage generator 16 and a comparator 15. The reference voltage generator 16 is used for generating a reference voltage Vref. The comparator 15 is used for generating a result signal DS.

As shown in FIG. 3, the input terminal of the first digital-to-analog converter 11 is connected with the control circuit 10 for receiving the first digital video signal DV1, and the output terminal of the first digital-to-analog converter 11 is connected with the first video output terminal P1 for outputting the first analog video signal AV1. The first switch 141 is connected with the first video output terminal P1 and a first input terminal of the comparator 15. The second switch 142 is connected between the output terminal of the first bias voltage generator 13 and the first input terminal of the comparator 15. The output terminal of the comparator 15 is connected with the control circuit 10. Moreover, the reference voltage Vref generated from the reference voltage generator 16 is inputted into a second input terminal of the comparator 15. Generally, the reference voltage Vref is between the first detecting voltage and the second detecting voltage. The operations of the first switch 141 and the second switch 142 are similar to those of the first embodiment, and are not redundantly described herein.

When the first digital-to-analog converter 11 is enabled, the first digital video signal DV1 with a detecting value is generated by the control circuit 10. Consequently, the first analog video signal AV1 outputted from the first digital-to-analog converter 11 is a constant detecting current. When the first video output terminal P1 generates the first detecting voltage, the first detecting voltage is smaller than the reference voltage Vref. Consequently, the result signal DS in a first voltage level state is outputted from the comparator 15. According to the first voltage level state of the result signal DS, the control circuit 10 judges that the video output system 200 is connected with the display device 30. On the other hand, when the first video output terminal P1 generates the second detecting voltage, the second detecting voltage is larger than the reference voltage Vref. Consequently, the result signal DS in a second voltage level state is outputted from the comparator 15. According to the second voltage level state of the result signal DS, the control circuit 10 judges that the video output system 200 is not connected with the display device 30.

Moreover, when the first digital-to-analog converter 11 is disabled, the first bias voltage generator 13 is enabled by the control circuit 10. Consequently, the first bias voltage generator 13 provides the constant detecting current. When the first video output terminal P1 generates the first detecting voltage, the first detecting voltage is smaller than the reference voltage Vref. Consequently, the result signal DS in the first voltage level state is outputted from the comparator 15. According to the first voltage level state of the result signal DS, the control circuit 10 judges that the video output system 200 is connected with the display device 30. On the other hand, when the first video output terminal P1 generates the second detecting voltage, the second detecting voltage is larger than the reference voltage Vref. Consequently, the result signal DS in the second voltage level state is outputted from the comparator 15. According to the second voltage level state of the result signal DS, the control circuit 10 judges that the video output system 200 is not connected with the display device 30.

Similar to the description of the second embodiment, the first switch and the second switch may be exempted from the video output system 200 of the third embodiment. The other components and the connecting relationships between these components are similar to those of the second embodiment, and are not redundantly described herein.

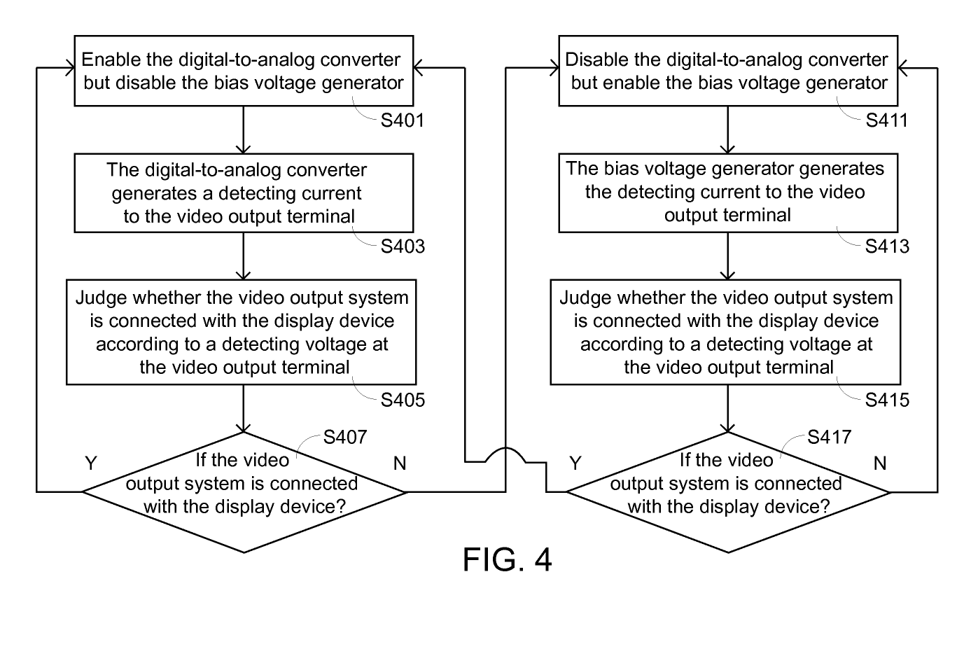

FIG. 4 is a flowchart illustrating a load detecting method for a video output system according to an embodiment of the present invention. The load detecting method of the present invention can be performed during a load detecting time interval. The flowchart may be started from the step S401 or the step S411. In the step S401, the digital-to-analog converter is enabled, but the bias voltage generator is disabled. In the step S403, the digital-to-analog converter generates a detecting current to the video output terminal. Then, the step S405 is performed to judge whether the video output system is connected with the display device according to a detecting voltage at the video output terminal. If the video output system is connected with the display device in the step S407, the step S401 is repeatedly done. Whereas, if the video output system is not connected with the display device in the step S407, the step S411 is performed.

In the step S411, the digital-to-analog converter is disabled, but the bias voltage generator is enabled. In the step S413, the bias voltage generator generates the detecting current to the video output terminal. Then, the step S415 is performed to judge whether the video output system is connected with the display device according to a detecting voltage at the video output terminal. If the video output system is connected with the display device in the step S417, the step S401 is repeatedly done. Whereas, if the video output system is not connected with the display device in the step S417, the step S411 is performed.

In other words, if the control circuit judges that the video output system is connected with the display device, the detecting current generated from the digital-to-analog converter is used to detect whether the video output system is continuously connected with the display device. Whereas, if the control circuit judges that the video output system is not connected with the display device, the detecting current generated from the bias voltage generator is used to detect whether the video output system is not continuously connected with the display device.

In the above embodiments, the flowchart of the load detecting method may be automatically executed by firmware. That is, the operations of associated components may be monitored and implemented in real time. By the video output system of the present invention, the circuitry complexity is effectively reduced. Regardless of whether the digital-to-analog converter is enabled or disabled, the video output system can effectively judge whether the video output terminal is connected with the load. By determining whether the video output system is connected with the load, the digital-to-analog converter of the video output system is selectively enabled or disabled. Consequently, the applications of playing video signals are enhanced, and the power-saving efficacy is enhanced.

As a consequence, the video output system and the load detecting method of the present invention can solve the problems of the prior art technology while achieving the industrial values.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video output system having a function of detecting whether the video output system is connected with a display device during a load detecting time interval, the video output system at least comprising:
a first video output terminal selectively connected with a first video input terminal of the display device through a signal cable;
a control circuit for generating a first digital video signal, a first control signal and a second control signal;
a first digital-to-analog converter, wherein when the first digital-to-analog converter is enabled according to the first control signal, a detecting value of the first digital video signal is converted into a constant detecting current to the first video output terminal by the first digital-to-analog converter; and
a first bias voltage generator, wherein when the first digital-to-analog converter is disabled according to the first control signal, the first bias voltage generator is enabled according to the second control signal, so that the first bias voltage generator generates the constant detecting current to the first video output terminal,
wherein according to the constant detecting current, the first video output terminal has a detecting voltage for indicating whether the video output system is connected with the display device, wherein when the video output system is connected with the display device, the control circuit enables the first digital-to-analog converter but disables the first bias voltage generator, wherein when the video output system is not connected with the display device, the control circuit disables the first digital-to-analog converter but enables the first bias voltage generator.

2. The video output system as claimed in claim 1, wherein the video output system further comprises a first resistor, and the first resistor is connected between the first video output terminal and a first ground terminal, wherein the display device further comprises a second resistor, and the second resistor is connected between the first video input terminal and a second ground terminal.

3. The video output system as claimed in claim 1, further comprising:
a first analog-to-digital converter having an output terminal connected with the control circuit;
a first switch connected between the first video output terminal and an input terminal of the first analog-to-digital converter, wherein when the first digital-to-analog converter is enabled or when the first digital-to-analog converter is disabled but the first bias voltage generator is enabled, the first switch is turned on; and
a second switch connected between an output terminal of the first bias voltage generator and the input terminal of the first analog-to-digital converter, wherein when the first digital-to-analog converter is enabled, the second switch is turned off, wherein when the first digital-to-analog converter is disabled but the first bias voltage generator is enabled, the second switch is turned on.

4. The video output system as claimed in claim 3, wherein the first analog-to-digital converter generates a first result value or a second result value to the control circuit according to the detecting voltage, wherein by comparing the first result value or the second result value with a threshold value, the control circuit determines whether the video output system is connected with the display device or disconnected from the display device.

5. The video output system as claimed in claim 1, further comprising a first analog-to-digital converter, wherein an output terminal of the first analog-to-digital converter is connected with the control circuit, and an input terminal of the first analog-to-digital converter is connected with the first video output terminal and the first bias voltage generator, wherein the first analog-to-digital converter generates a first result value or a second result value to the control circuit according to the detecting voltage, wherein by comparing the first result value or the second result value with a threshold value, the control circuit determines whether the video output system is connected with the display device or disconnected from the display device.

6. The video output system as claimed in claim 1, further comprising:
a comparator having an output terminal connected with the control circuit;
a first switch connected with the first video output terminal and a first input terminal of the comparator, wherein when the first digital-to-analog converter is enabled or when the first digital-to-analog converter is disabled but the first bias voltage generator is enabled, the first switch is turned on;
a second switch connected between an output terminal of the first bias voltage generator and the first input terminal of the comparator, wherein when the first digital-to-analog converter is enabled, the second switch is turned off, wherein when the first digital-to-analog converter is disabled but the first bias voltage generator is enabled, the second switch is turned on; and
a reference voltage generator for generating a reference voltage to a second input terminal of the comparator.

7. The video output system as claimed in claim 6, wherein by comparing the reference voltage with the detecting voltage, the comparator generates a result signal to the control circuit, wherein according to the result signal, the control circuit determines whether the video output system is connected with the display device or disconnected from the display device.

8. The video output system as claimed in claim 1, further comprising:
a reference voltage generator for generating a reference voltage; and
a comparator, wherein an output terminal of the comparator is connected with the control circuit, a first input terminal of the comparator is connected with an output terminal of the first bias voltage generator and the first video output terminal, and a second input terminal of the comparator receives the reference voltage,
wherein by comparing the reference voltage with the detecting voltage, the comparator generates a result signal to the control circuit, wherein according to the result signal, the control circuit determines whether the video output system is connected with the display device or disconnected from the display device.

9. The video output system as claimed in claim 1, wherein the load detecting time interval is a time interval while a first analog video signal is not outputted from the first digital-to-analog converter, or the load detecting time interval indicates a vertical blank interval of the first analog video signal.

10. The video output system as claimed in claim 9, wherein the first analog video signal is a composite video broadcast signal, a separate video signal, a YUV signal or a RGB signal.

11. A load detecting method for detecting whether a video output system is connected with a display device during a load detecting time interval, the video output system comprising a video output terminal, a digital-to-analog converter and a bias voltage generator, the video output terminal being selectively connected with the display device, the load detecting method comprising steps of:
(a1) enabling the digital-to-analog converter but disabling the bias voltage generator;
(a2) allowing the digital-to-analog converter to generate a detecting current to the video output terminal;
(a3) judging whether the video output system is connected with the display device according to a detecting voltage at the video output terminal;
(a4) if the video output system is connected with the display device, repeatedly performing the step (a1), or if the video output system is not connected with the display device, performing a step (b1);
(b1) disabling the digital-to-analog converter but enabling the bias voltage generator;
(b2) allowing the bias voltage generator to generate the detecting current to the video output terminal;
(b3) judging whether the video output system is connected with the display device according to the detecting voltage at the video output terminal; and
(b4) if the video output system is connected with the display device, repeatedly performing the step (a1), or if the video output system is not connected with the display device, performing the step (b1).

12. The load detecting method as claimed in claim 11, wherein if the detecting voltage is larger than a reference voltage, the video output system is not connected with the display device, wherein if the detecting voltage is smaller than the reference voltage, the video output system is connected with the display device.

13. The load detecting method as claimed in claim 11, wherein the load detecting time interval is a time interval while a first analog video signal is not outputted from the first digital-to-analog converter, or the load detecting time interval indicates a vertical blank interval of the first analog video signal.
